(19) United States
(12) Patent Application Publication
(10) Pub. No.: US 2013/0278416 A1
(43) Pub. Date: Oct. 24, 2013

(54) METHODS FOR LOCATING INDIVIDUALS IN AN EMERGENCY CONDITION USING AN AD-HOC NETWORK AND DEVICES THEREOF

(71) Applicants: Adam Button, Pacific Palisades, CA (US); Michael Gregory Pettus, Laguna Niguel, CA (US); Randall Breitenbach, Los Angeles, CA (US)

(72) Inventors: Adam Button, Pacific Palisades, CA (US); Michael Gregory Pettus, Laguna Niguel, CA (US); Randall Breitenbach, Los Angeles, CA (US)

(73) Assignee: ResQMe, Pacific Palisades, CA (US)

(21) Appl. No.: 13/455,077

(22) Filed: Apr. 24, 2012

(51) Int. Cl. G08B 1/08

(52) U.S. Cl. 340/539.13

(57) ABSTRACT

An emergency locator apparatus includes a transceiver configured to periodically send and receive communications with a plurality of other emergency locator apparatus including a target emergency locator apparatus using an ad-hoc wireless local area network. A processor is operably coupled to the transceiver and configured to determine location information of the target emergency locator apparatus utilizing at least context information associated with the communications received from at least a subset of the plurality of other emergency locator apparatus over the ad-hoc wireless local area network. A display is configured to display the location information determined by the processor.

### FIELD

This technology generally relates to locating an individual in an emergency condition and, more particularly, to methods and devices for locating one or more individuals using context information associated with communications continuously transmitted by an emergency locator apparatus worn by the individual(s) and received at one or more other emergency locator apparatus over an ad-hoc wireless local area network.

### BACKGROUND

The ability to quickly and accurately locate individuals in an emergency condition during a search and rescue is critical irrespective of the cause of the emergency. Following an avalanche, hurricane, typhoon, earthquake, fire, tsunami or other natural disaster, for example, a first responder's ability to locate victims quickly can increase the chances of the victims' survival.

In one scenario, avalanche beacons have been developed which include transceivers capable of transmitting and receiving signals in a relatively low portion of the medium frequency electromagnetic spectrum, such as at 457 kHz. Such avalanche beacons can be worn by individuals participating in skiing or other snow sports, particularly in areas susceptible to avalanches and/or in relatively isolated, remote, or back country terrain.

However, in order to find a downed skier the avalanche beacons worn by other skiers have to be manually converted from a transmit mode to a receive mode in order to listen for the transmissions of the avalanche beacon worn by the downed skier This consumes what may be critical time with respect to the health or survival of the downed skier.

Additionally, if any of the other skiers are unaware that another skier is in peril, and the avalanche beacons associated with the unaware skier(s) continue transmitting, these transmitting signals may complicate the search for the downed skier and delay any rescue. Further, the range of such avalanche beacons is approximately 15 meters or less, which is insufficient in many environments. Moreover, existing avalanche beacon devices lack the precision necessary in determining the downed skier's location, often resulting in additional undesirable delay.

In order to address the deficiencies of the avalanche beacons operating based on a 457 kHz signal, including the limited range, emergency locating devices using global positioning system (GPS) receivers have been developed. However, such devices generally require satellite access which is often unavailable, including in back country terrain with steep valleys or canyons, for example.

Other emergency locating device including IEEE 802.11 transceivers have been developed. However, such devices require an existing wireless network infrastructure having near access points and cell towers. These IEEE 802.11 transceivers utilize the cell towers and access points for purposes of handling voice and data communications. Additionally, the IEEE 802.11 transceivers leverage triangulation and/or other positioning techniques by leveraging the known locations of the access points/cell towers in order to locate the downed individual. Accordingly, such devices are not capable of locating individuals in environments where the wireless networking infrastructure is unavailable, such as in back country terrain or after a natural disaster.

What is need is an emergency locating device capable of locating a downed individual utilizing a close-range ad-hoc wireless communications network.

### SUMMARY

In an aspect, an emergency locator apparatus includes a transceiver configured to periodically send and receive communications with a plurality of other emergency locator apparatus including a target emergency locator apparatus using an ad-hoc wireless local area network. A processor is operably coupled to the transceiver and configured to determine location information of the target emergency locator apparatus utilizing at least context information associated with the communications received from at least a subset of the plurality of other emergency locator apparatus over the ad-hoc wireless local area network. A display is configured to display the location information determined by the processor.

In an aspect, a method for locating individuals in an emergency condition is disclosed. The method includes periodically sending and receiving, with an emergency locator apparatus, communications with a plurality of other emergency locator apparatus including a target emergency locator apparatus using an ad-hoc wireless local area network. Location information of the target emergency locator apparatus is determined with the emergency locator apparatus, utilizing at least context information associated with the communications received from at least a subset of the plurality of other emergency locator apparatus over the ad-hoc wireless local area network. The location information is output, with the emergency locator apparatus, to a display.

A system for locating individuals in an emergency condition including a plurality of emergency locator apparatus including a transceiver configured to periodically send and receive communications with each other of the plurality of emergency locator apparatus over an ad-hoc wireless local area network. A target emergency locator apparatus includes a transceiver configured to periodically send and receive communications with each of the plurality of emergency locator apparatus and a processor operably coupled to the transceiver and configured to determine that a user of the target emergency locator is in an emergency condition and send an emergency condition communication to each of the plurality of emergency locator apparatus. Each of the plurality of emergency locator apparatus further includes a processor operably coupled to the transceiver and configured to receive the emergency condition communication and determine location information of the target emergency locator apparatus, in response to the emergency condition communication, utilizing at least context information associated with the communications received from the target emergency locator apparatus and each other of the plurality of emergency locator apparatus.

This technology provides a number of advantages including more effective methods and devices for locating individuals in an emergency condition. With this technology, each of a plurality of emergency locator apparatus periodically sends and receives communications with each other of the plurality of emergency locator devices using an ad-hoc wireless local area network. Context information associated with the communications is used to locate a target emergency locator device worn by an individual in an emergency condition. Thereby, infrastructure and satellite connectivity are not required to locate an individual, range of connectivity can be increased, and response time can be reduced. Optionally, data from one or more other available sources and/or sensors, such as a global positioning system (GPS) receive and/or a 457 kHz transceiver, for example, can be aggregated to thereby further increase the effectiveness of this technology.

### BRIEF DESCRIPTION OF THE DRAWINGS

FIG. 1 is a block diagram of an ad-hoc wireless local area network which incorporates exemplary emergency locator apparatus including a guide unit emergency locator apparatus and a target emergency locator apparatus in accordance with an aspect of the present disclosure;

FIG. 2 is a block diagram of an exemplary emergency locator apparatus in accordance with an aspect of the present disclosure; and

FIG. 3 is a flowchart of an exemplary method for locating individuals in an emergency condition in accordance with an aspect of the present disclosure.

### DETAILED DESCRIPTION

In general, the present system and method is directed to an emergency locator apparatus which is designed to operate in conjunction with other emergency locator apparatus to find one or more target object who also has an emergency locator apparatus. Each emergency locator apparatus is configured to establish, maintain and utilize a standalone or mesh wireless network that operates independent of any existing wireless network infrastructure. A standalone ad-hoc network is advantageous in locating the target object as no ground-based or satellite infrastructure is needed to communicate data among the locator units. Each unit, including the target unit, uses sensor data and continually shares that data with one another over the standalone network to iteratively calculate the location of the target object.

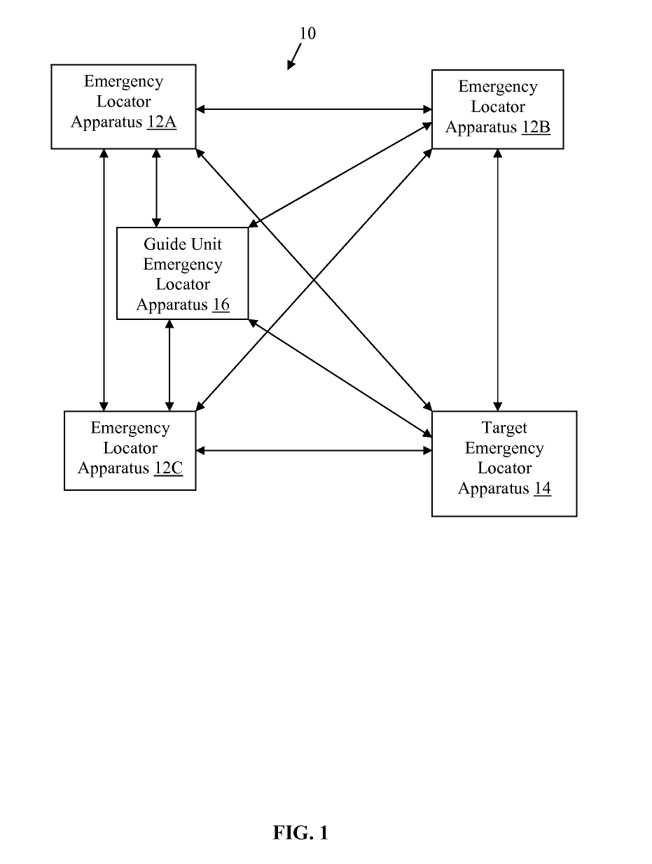

FIG. 1 is a block diagram of an ad-hoc wireless local area network which incorporates one or more emergency locator apparatus, one or more guide unit emergency locator apparatus and one or more target emergency locator apparatus in accordance with an aspect of the present disclosure. An ad-hoc wireless local area network 10 generated between a plurality of emergency locator apparatus 12A-12C, a target emergency locator apparatus 14 of a downed or target object and a guide unit emergency locator apparatus 16. In particular, as will be discussed in more detail below, the wireless ad-hoc network 10 is a closed, standalone local area or mesh network through which the guide unit 16 as well as other locator apparatus 12A-12C are able to communicate with one another and the target apparatus 14 to locate the downed individual without the need of existing network infrastructure, satellites or other devices which serve to provide a wireless network.

It should be noted that although only three emergency locator apparatus 12A-12C, one target unit 14 and one guide unit 16 are shown in FIG. 1, any number of units are contemplated. The network 10 can include other numbers and types of systems, devices, components, and elements in other configurations, such as multiple numbers of each of these apparatus.

In an aspect, the emergency locator apparatus 12A-12C as well as the target unit 14 have the same or similar features, whereas the guide emergency locator apparatus 16 has additional features not present in units 12A-12C, 14. The guide emergency locator apparatus 16 is typically carried by a guide, expert or leader of the individuals trying to locate the target object. The guide emergency locator apparatus 16 is generally more powerful and more robust than the other units 12A-12C, 14 and performs more detailed functions than the other standard units. The guide unit 16 communicates with the other units 12A-12C, 14 via a Bluetooth link or the network 10 and utilizes context data of the other units 12A-12C, 14 as well as its own context data to locate the target object 10. For instance, the guide unit 16 may contain a microphone, a voice to text converter component, and a visual display which displays the other units 12A-12C, 14 and their locations with respect to the guide unit 16. The guide unit emergency locator apparatus 16 can include a relatively more robust processor 13, display 20, and/or power supply (not shown), as compared to that of the other emergency locator apparatus 12A-12C, 14.

For exemplary purposes only, emergency locator apparatus 14 has been identified in FIG. 1 as the target emergency locator apparatus. However, any of the other emergency locator apparatus 12A-12C and/or 16 can be the target emergency locator apparatus based on whether the individual carrying the locator apparatus has suffered injury and needs assistance. In an aspect, the target emergency locator apparatus is attached to a target object, which may be a human person, animal, inanimate object, or the like. It should be noted that although the present disclosure primarily describes the function and use of the emergency locator apparatus for locating the target object in an emergency setting, it is contemplated that the novel system and method may be utilized in a recreational, commercial and/or industrial setting without being limiting in any way.

It should be noted that any of the other emergency locator apparatus 12A-12C, 14 can be the guide unit emergency locator apparatus 16 in an aspect. In an aspect, the guide unit emergency locator apparatus 16 may be optional and may not be present in the network 10.

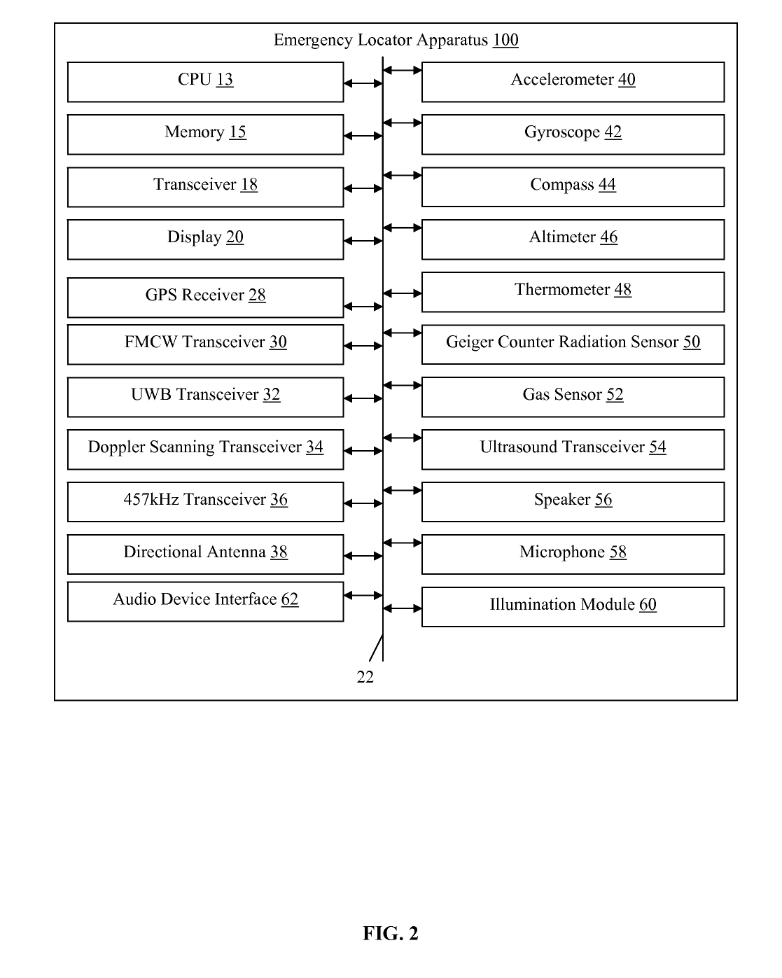

FIG. 2 is a block diagram of an exemplary emergency locator apparatus in accordance with an aspect of the present disclosure. For clarity, the emergency locator apparatus in FIG. 2 has a reference numeral of 100. However, it should be noted that the description of the emergency locator apparatus 100 in FIG. 2 may apply to any or all of the emergency locator apparatus 12, 14, 16 in FIG. 1. Referring to FIGS. 1-2, the emergency locator apparatus 100 may include one or more central processing units (CPU) or processors 13, one or more memory storage means 15, one or more network interface devices or transceivers 18, and a display 20, all of which are coupled together by a bus 22 or other link. Although not shown, each apparatus 100 includes a battery source to power the unit 100, whereby battery is configured to allow power consumption between 7 mW and 100 mW, although other ranges are contemplated. It should be noted that other numbers and types of systems, devices, components, and elements in other configurations and locations can be used.

The processor 13 in the emergency locator apparatus 100 is configured to execute a program of stored instructions stored in memory 15 for one or more aspects of the present technology as described and illustrated by way of the examples herein. Additionally, other types and numbers of processing devices and configurable hardware logic such as one or more field programmable gate arrays (FPGAs), field programmable logic devices (FPLDs), application specific integrated circuits (ASICs), and/or programmable logic units (PLUs) could be used in place of or in combination with the processor 13. One example of the processor 13 may be the Samsung™ Exynos ARM Cortex-A9 processor, although it should be noted that any other appropriate processor 13 is contemplated for use in the apparatus 100.

The memory 15 in the emergency locator apparatus 100 is configured to store programmed instructions for one or more aspects of the present technology as described and illustrated herein. A variety of different types of memory storage devices, such as a random access memory (RAM), read only memory (ROM), flash, hard disk, and/or any other computer readable medium which is read from and written to by a magnetic, optical, or other reading and writing system that is coupled to the processor 13, can be used for the memory 15. Accordingly, the memory 15 can include a non-transitory computer readable medium having programmed instructions for one or more aspects of the present technology stored thereon, which when executed by the processor 13, cause the processor 13 to carry out the steps necessary to implement the methods described and illustrated by way of the examples herein. The memory 15 is configured to contain executable software code which allows basic operating system functions to be carried out on the emergency locator apparatus 100.

In an aspect, each emergency locator apparatus 100 runs a software based locator application which is stored in the memory 15 or other storage means, whereby the locator application includes code-based executable instructions which, when executed by the processor 13, causes the emergency locator apparatus 100 to perform the steps and functions related to establishing, maintaining and utilizing the network 10. The locator application is also configured to instruct the processor and other components in the emergency locator apparatus 100 to communicate context data, process received context data, calculate the location of the target emergency locator apparatus 14 as well as transmit confirmation messages, perform voice to text conversion functions, and other functions described herein.

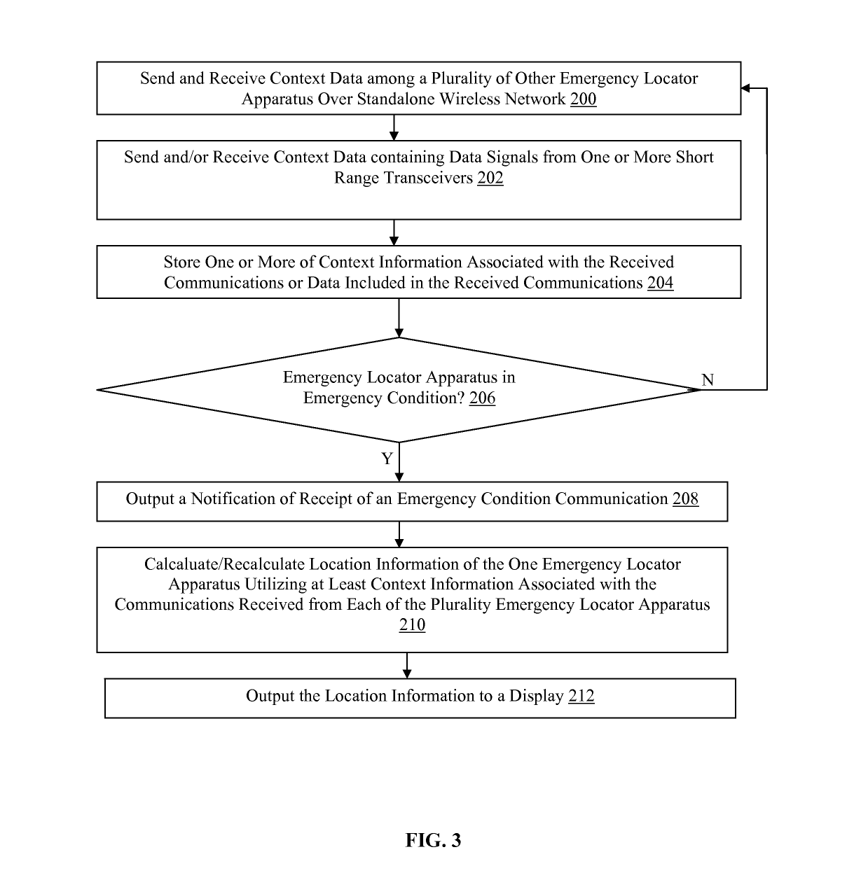

Each emergency locator apparatus 100 utilizes one or more transceivers 18 to send and receive wireless data signals over the network 10. In an aspect, the transceiver 18 is configured to be coupled to an omni-directional antenna, although it is not necessary. In an aspect, as shown in FIG. 3, an additional/alternative transceiver may be coupled to a directional antenna 38.

Each emergency locator apparatus 100 can utilize TCP, UDP or other Layer 4 protocol to send and receive data packets over the network 10. One example of the transceiver 18 may be the Broadcom™ BCM43142 combo Wi-Fi and Bluetooth transceiver chip, although it should be noted that any other appropriate transceiver 18 is contemplated for use in the apparatus 100. One example of the directional antenna 38 may be the L-Com™ HG2409P-NF Patch Antenna, although it should be noted that any other appropriate directional antenna 38 is contemplated for use in the apparatus 100.

In an aspect, only the transceiver 18 is used to communicate via the ad hoc network 10. In the event that the network fails 10, the units 100 will cease using the transceiver 18 will operate in a one-way beacon transmitting mode (using a 457 kHz transceiver). When in beacon mode, each unit will use the 457 kHZ transceiver to send the beacon ID of the transmitting unit. In an aspect, the Equivalent Isotropically Radiated Power (EIRP) for the transceiver 18 may be within, and including, a range of 50 to 500 mW. In an aspect, the output range of each transceiver utilizing the network 10 is in the order of 100 meters, although other ranges are contemplated. In contrast, the range for typical 457 kHz signals is between 10 to 20 meters.

As mentioned, the emergency locator apparatus 100 is configured to create, maintain and utilize a standalone, independent wireless ad-hoc local are or mesh network 10, whereby each emergency locator apparatus 100 designated to use the network 10 can communicate data, such as context data, with one another when no desirable means of wirelessly communicating is available (e.g. terrain, disaster event, outside Bluetooth range, etc.). The network 10 used among the various emergency locator apparatus allows communications, including context data, in conformance with the IEEE 802.11 protocol. The context information can include a received signal strength indicator (RSSI) value obtained in a preamble stage of receiving one or more of the IEEE 802.11 frames. In an aspect, RSSI values can be sampled from the preamble portion of the 802.11 frame. In an aspect where the 802.11 protocol allows use of Received Channel Power Indication (RCPI), the value is sampled from both the preamble portion and the entire received frame. Additionally or alternatively, the context information can include round trip time (RTT) information of communications sent between two emergency locator apparatus. Using the RSSI context information, the power level of communications received at the directional antenna 38 can be used by the processor 13 to determine the relative distance of each of the emergency locator apparatus 12A-12C, 16 from the target emergency locator apparatus 14. Additionally, based on the round trip times associated with communications with one or more of the other emergency locator apparatus 12A-12C, 16 the processor 13 of each of the emergency locator apparatus 12A-12C, 16 can determine the relative distance and direction of the target emergency locator apparatus 14. It should be noted, however, that any other method of calculating the time required for a communication to be sent by one of the emergency locator apparatus 12A-12C, 16 and received by another of the emergency locator apparatus 12A-12C, 16 is contemplated.

In an aspect, one or more emergency locator apparatus 100 includes one or more short-range transceivers act like sensors which provide the context data that is communicated to the other units over the ad hoc network 10. In an aspect, however, two or more emergency locator units can utilize the short-range transceivers to send and receive data signals if they are within a certain distance from one another. In this aspect, signals can be transmitted as a transponder in which signals are transmitted in a one-way beacon-like manner.

Examples of short-range transceivers include, but are not limited to, a frequency modulated continuous-wave (FMCW) transceiver 30, an ultra-wide band (UWB) transceiver 32, and/or a 2.4 GHz Doppler scanning transceiver 34. In an aspect, the Doppler transceiver 34, may includes an antenna sub-system which utilizes azimuth angle and elevation information as sensor data which may be used to locate the target unit 14. The antenna output for the FMCW and Doppler transceivers 30, 34 is contemplated within, and including, 1 to 3 meters, although other ranges are contemplated. One example of the FMCW transceiver 30 may be the Vubig™ V60TXWG2N60RXWG2 transceiver, although it should be noted that any other appropriate transceiver 30 is contemplated for use in the apparatus 100. One example of the Doppler transceiver 34 may be the Broadcom™ BCM4312 transceiver, although it should be noted that any other appropriate transceiver 34 is contemplated for use in the apparatus 100.

In an aspect, the emergency locator apparatus 100 may include a 457 kHz transceiver 36, and/or an ultrasound transceiver 54. In an aspect, the emergency locator apparatus 100 includes a directional patch antenna 38 coupled to the transceiver 18, whereby the communications are sent and received via the antenna 38. Optionally, the transceiver 18 is further configured to operate in a standard infrastructure mode.

One or more of the transceivers 30-36 in the emergency locator apparatus 100 can be configured to measure relative location, such as distance and direction data, whereby that relative location data may be sent by the transceiver 18 as or with context data over the network 10 between it and the target emergency locator apparatus 14. In an aspect, the relative location data is calculated using relative strength of the signals from the transceivers 18, 30-36, RTT data, RSSI data and/or any other data. This relative location data is included with the context data that is sent to the other emergency locator apparatus 100. Other types and numbers of communication networks, protocols or systems with other types and numbers of connections and configurations can also be used. In an aspect, each emergency locator apparatus 100 that can access the standalone local area network 10 is preconfigured by a user or administrator such that it can automatically access the network 10 and communicate data only with other known emergency locator apparatus that have been designated to access and use the network 10.

In another aspect, the emergency locator apparatus 100 may include one or more sensors configured to provide sensor data to the processor 13, whereby the sensor data may be included with or part of the context data that is sent and received between emergency locator apparatus. In an aspect, these sensors may include, but are not limited to, a global positioning system (GPS) receiver 28, an accelerometer 40, a gyroscope 42, a compass 44, an altimeter 46, a thermometer 48, a Geiger counter radiation sensor 50, a gas sensor 52 and the like.

In an aspect, the sensor data may monitor speed, location and orientation data over a set amount of time and provide that information to the processor 13. In one example, the accelerometer 40 and/or gyroscope 42 can be used to determine whether the emergency locator apparatus 100 (and thus the individual to which the apparatus is attached) is currently motionless or moving and/or is in a particular orientation with respect to ground (e.g. upside down). In an aspect, the accelerometer 40 and/or gyroscope 42 can monitor and record sensed data of the emergency locator apparatus 100 during the time period when the target individual had fallen. In an aspect, the accelerometer 40 and/or gyroscope 42 can record and analyze random movements, speeds and/or orientations of the emergency locator apparatus 100 (and thus the individual) over a set period of time. In an aspect, the sensor data is analyzed by the processor 13, whereby the processor 13 may apply the sensed data against one or more algorithms and/or logic tables to conclude that the individual has fallen and is in an emergency condition.

In an aspect, the emergency locator apparatus 100 may utilize one or more other sensors to monitor the downed individual's breathing, heart rate, temperature and/or pulse. In an aspect, the target emergency locator apparatus 14 may be configured to send some or all of this information with the context data to one or more of the other emergency locator apparatus 12A-12C, 16 via the network 10.

In an aspect, the emergency locator apparatus 100 can include a Geiger counter radiation sensor 50 and/or gas sensor 52 that can be used to determine a change in the environment (e.g. a possible earthquake or avalanche) in the area near the downed individual. The compass 44 and altimeter 46 can be used to determine the physical position including orientation of the target emergency locator apparatus 14. A temperature sensor 48 can be used to monitor body temperature of the downed individual and/or the individual's surrounding environment. In an aspect, the emergency locator apparatus 100 send some or all of this information as context data to one or more of the other emergency locator apparatus via the network 10.

In an aspect, the sensor data may be received from sensors directly integrated into the individual's clothing (e.g. ski suit, fire suit, military suit) to monitor blood pressure, heart rate, muscle activity, other biometric, environment measurements, and the like.

In an aspect, one or more of the emergency locator apparatus optionally includes an audio device interface 62 coupled to a speaker 56 and/or a microphone 58. The audio device interface 62 is configured to emit audible signals using the speaker 56 for notification purposes. The audio device interface 62 can further be configured to receive and process audible signals received by the microphone 58, as well as convert digital audio signals for analog output by the speaker 56. One exemplary application of the audio device interface 62 is for facilitating voice over Internet protocol (VoIP) communications. It is contemplated that one or more emergency locator apparatus 100 include a force feedback device (e.g. vibrating actuator) which provides haptic effects to the downed individual.

It an aspect, the speaker 56 of the target emergency locator apparatus 14 may be configured to automatically emit an audible sound immediately after sending the emergency distress signal, whereby the sound would serve to aid the other individuals in locating the target. In an aspect, upon the emergency locator apparatus sending the emergency distress signal, the speaker 56 and microphone 58 may be configured to automatically switch on to allow communications between the target emergency locator apparatus 14 and one or more other emergency locator apparatus 12A-12C, 16. In a particular example, audible communications would be shared only between the target emergency locator apparatus 14 and the guide emergency locator apparatus 16 in the emergency mode.

In yet other examples, one or more of the emergency locator apparatus 100 can include an illumination module 60 having one or more light emitting diodes (LEDs) or other light emitting device (e.g. infrared). The illumination module 60 can be configured to provide relatively close range illumination of the location of a target emergency locator apparatus 14, as described and illustrated in more detail below.

In an example aspect, each emergency locator apparatus sends context data to the guide emergency locator apparatus 16 when the there is no apparatus 100 to target (i.e. ‘non-emergency’ or ‘normal’ mode). In the example aspect, upon at least one emergency locator apparatus receiving the emergency distress signal from another (target) emergency locator apparatus 14, all emergency locator apparatuses 12A-12C, 14, 16 will go into ‘emergency mode’. In an aspect, the emergency distress signal will include data identifying the transmitting target emergency locator apparatus 14 as well as its context data. The emergency distress signal is preferably continually transmitted from the target emergency locator apparatus 14 until the target individual is found. In an aspect, the emergency distress signal is sent in a single-hop fashion among the other emergency locator apparatus 12A-12C, 16. In another aspect, the emergency distress signal is sent in a multi-hop fashion among the other emergency locator apparatus 12A-12C, 16, whereby the distress signal is repeatedly transmitted among units where direct communications may not be feasible.

Once in emergency mode, each emergency locator apparatus 12A-12C identifies the target emergency locator apparatus 14 and continues to receive the emergency distress signal from the target 14. Each emergency locator apparatus 12A-12C, 16 will utilize context data from the target emergency locator apparatus 14 to calculate its relative position to the target emergency locator apparatus 14. This relative position data is included with that emergency locator apparatus's context data, which is then automatically transmitted to the other emergency locator apparatus 12, 16. The other emergency locator apparatus 12, 16, upon receiving this relative position data (and context data) from the relaying emergency locator apparatus, is able further triangulate and recalculate its own position with respect to the target emergency locator apparatus 14. In other words, by each emergency locator apparatus sharing its own context data and its estimated relative location data with one another, the location of the target emergency locator apparatus 14 can be determined in a much quicker, more efficient manner.

For example, with respect to FIG. 1, emergency locator apparatus 12A may receive context data from target emergency locator apparatus 14. Based on this received context data, emergency locator apparatus 12A is able to calculate an estimated relative position between it and the target emergency locator apparatus 14. This relative position data, along with the context data of emergency locator apparatus 12A, is automatically transmitted to all the other emergency locator apparatus 12B, 12C, 14, 16. Meanwhile the other apparatus 12B, 12C, 14, 16 calculate an estimated relative position between themselves and the target emergency locator apparatus 14. In the example, apparatus 12B receives the context data, including relative position data, from apparatus 12A and determines the relative location between apparatus 12A and 12B using the context data from 12A as well as apparatus 12B's own location. Additionally, apparatus 12B determines the relative location between apparatus 12A and the target apparatus 14 from the context data sent from apparatus 12A. The same process occurs between and among the other emergency locator apparatus to eventually pinpoint the location of the target emergency locator apparatus 14.

FIG. 3 is a flowchart of an exemplary method for locating individuals in an emergency condition in accordance with an aspect of the present disclosure. For purposes of explanation, the following example is described in a scenario where emergency locator apparatus are used to locate one or more downed skiers in back country terrain. However, it should be noted that the emergency locator apparatus may be used in other emergency or non-emergency scenarios where the locator apparatus are used to locate one or more target objects and/or individuals through their target apparatus and by communicating data over the closed, close-range ad-hoc local area or mesh network established between the designated locator apparatuses.

Returning to the example scenario, each of the emergency locator apparatus 12A-12C and 14 are worn by skiers and the guide unit emergency locator apparatus 16 is worn by a lead or guide skier. In particular to the locator apparatus 14, it should be noted that this target locator apparatus 14 may be the same as any of the apparatus 12A-12C or 16, but is designated with reference numeral 14 as the individual wearing locator apparatus 14 is considered downed and in need of emergency assistance.

With respect to the example scenario, the skiers may be in back country terrain where wireless network access point(s) or infrastructure may not be available. Additionally, considering the geographic terrain, GPS satellite reception may be intermittent and/or nonexistent. Within the example, one or more of the skiers may be separated from at least one other skier by a distance of more than 15 meters, thereby rendering 457 kHz signal reception, typically used with most emergency locator apparatus, unreliable.

Accordingly, in this example, at step 200 each of the emergency locator apparatus periodically or continually sends its context data, via its respective transceiver 18, to one or more other emergency locator apparatus 12A-12C, 14, 16 over the ad-hoc wireless local area network 10. In an aspect, each emergency locator apparatus transmits its context data to only the guide unit 16 in the ‘normal’ mode. In this aspect, each emergency locator apparatus transmits its context data as well as relative location data (with respect to the target unit 14) to all the other units when in the ‘emergency’

In an aspect, one or more of the plurality of other emergency locator apparatus can forward, cascade, and/or broadcast some or all of the communications to one or more other emergency locator apparatus in the ad-hoc network 10. In one example, communications are sent and received relatively frequently or substantially continuously based on a period established by the manufacturer.

In an aspect, the communications are sent and received over the network 100 in conformance with the IEEE 802.11 protocol, whereby the communications can include context data and relative location data. The context information can include a received signal strength indicator (RSSI) value obtained in a preamble stage of receiving one or more of the IEEE 802.11 frames. In place of, or in combination with, the RSSI, the context information can include round trip time (RTT) information of communications sent between two emergency locator apparatus. It should be noted, however, that any other method of calculating the time required for a communication to be sent by one of the emergency locator apparatus 12A-12C, 14, 16 and received by another of the emergency locator apparatus 12A-12C, 14, 16 is contemplated. In an aspect, the context data can include data obtained from one or more sources within the transmitting locator apparatus, including but not limited to, data accumulated from the accelerometer 40, gyroscope 42, compass 44, altimeter 46, thermometer 48, and/or GPS receiver 28. Accordingly, in one example, whenever available, one or more emergency locator apparatus sends at least geographic coordinates or location data obtained from its respective GPS receiver 28, to at least one of the other emergency locator apparatus.

In an aspect, emergency locator apparatus 12A may automatically receive context information as a result of sending and receiving communications with target emergency locator apparatus 14. However, it may be useful for emergency locator apparatus 12A to obtain context information associated with communications between emergency locator apparatus 12B and target emergency locator 14, for example. For example, emergency locator apparatus 12B can periodically communicate context information, associated with communications between emergency locator apparatus 12B and target emergency locator apparatus 14 to emergency locator apparatus 12A. In some examples, a least a portion of the communications sent and received in step 200 are configured to include context information data such that one or more emergency locator apparatus is configured to obtain the context information associated with communications between all permutations of the other emergency locator apparatus.

In an aspect, as shown in optional step 202, one or more emergency locator apparatus communicates context data including information from one or more of the FMCW transceiver 30, UWB transceiver 32, 2.4 GHz Doppler scanning transceiver 34, 457 kHz transceiver 36, or ultrasound transceiver 54. In an aspect, one or more of the transceivers 30-36 and 54 can be in a transmit mode until an emergency condition communication is received from one of the other emergency locator apparatus 12A-12C, 14, 16, as described and illustrated in more detail below with respect to step 206. Upon receipt of an emergency condition communication, one or more of the transceivers 30-36 and 54 can convert to a receive mode (along with the transmission mode). The transceiver 30-36 and 54, including specifically the FMCW transceiver 30 and UWB transceiver 32 may emit signals that can penetrate snow pack but are reflected by objects or bodies concealed underneath, thereby potentially locating the downed individual.

At step 204, one or more of the emergency locator apparatus may store the context information in the received communications. Optionally, the guide unit emergency locator apparatus 16 includes a larger and/or more robust memory 15 configured to store all information received from all other emergency locator apparatus 12A-12C, 14 for at least a specified historical or rolling period of time. In one example, at least data output by the GPS receiver 28 is stored in the memory 15. As GPS receiver data may be only intermittently available, stored GPS receiver data can be used with other sensor and/or signal data to perform one or more dead reckoning techniques for purposes of determining location information of other locator apparatus 12A-12C as well as the target apparatus 14.

At step 206, one or more of the emergency locator apparatus 12A-12C and 16 receive an emergency condition communication from the target emergency locator apparatus 14. The processor 13 in one or more emergency locator apparatus can be configured to automatically determine that an emergency condition exists as well as identify the one or more target locator apparatus 14 sending the emergency condition communication.

Additionally, each unit 12A-12C, 16 receives context data from the target unit 14 based on data provided from the unit's 14 one or more of the sensors 40-48. For example, data output by the accelerometer 40 and/or gyroscope 42 may indicate the individual wearing the emergency locator apparatus 14 is not breathing, does not have a pulse, is currently accelerating or tumbling at a rate above a threshold, is upside down, and/or is motionless, or is otherwise in an emergency condition due to an avalanche or a tree hole, for example. While the accelerometer 40 and gyroscope 42 are provided in this exemplary embodiment, other sensors can be used to determine whether an individual associated with the target emergency locator apparatus is in need of emergency assistance.

In one example, emergency locator apparatus 12A-12C, 14, 16 can include an interface (not shown) such as a panic button, pull cord, or voice recognition, which provides a means for manual initiation of an emergency condition and subsequent transmission of the emergency distress signal or emergency condition communication. In an aspect, emergency locator apparatus 12A-C and 16 can broadcast information regarding the receipt of the emergency condition communication from the target emergency locator apparatus 14 to one another. Thereby, the other emergency locator apparatus 12A-12C and 16 can more effectively communicate the emergency condition and increase the likelihood the other emergency locator apparatus 12A-12C and 16, and associated individuals, are notified of the emergency condition detected by the target emergency locator apparatus 14.

At step 208, in response to receipt of the emergency condition communication from the target emergency locator apparatus 14, one or more of the other emergency locator apparatus 12A-12C and 16, are configured to output a notification including a visual signal using the display 20, a sensory signal such as a vibration, and/or an audible signal using the speaker 56. With the notification, the other skiers, in this example, can be alerted of the emergency condition detected by the target emergency locator apparatus 16.

At step 210, each of the emergency locator apparatus 12A-12C and 16 determines location information of the target emergency locator apparatus 14 utilizing at least the context information, described above. Using the RSSI context information, the power level of communications received at the directional antenna 38 can be used by the processor 13 to determine the relative distance of each of the emergency locator apparatus 12A-12C, 16 from the target emergency locator apparatus 14. Additionally, based on the round trip times associated with communications with one or more of the other emergency locator apparatus 12A-12C, 16, the processor 13 of each of the emergency locator apparatus 12A-12C, 16 can determine the relative distance and direction of the target emergency locator apparatus 14.

In an aspect, the context information is aggregated by the processor 13 with any available and/or stored data included in any of the communications received by emergency locator devices 12A-12C, 16. The context information can further be aggregated with signals received by any of the transceivers 30-36 and 54. By aggregating the information, the processor 13 can more effectively determine the location of the target emergency locator apparatus 14. In the event the individuals have been traversing terrain of significantly varying elevation rendering GPS reception intermittent, one or more dead reckoning techniques can be implemented by the processor 13. The dead reckoning techniques can use other communicated data including context information, signal data, and/or sensor data as well as the last known geographic coordinates or location of the target emergency locator apparatus 14.

At step 212, the processor 13 of each emergency locator apparatus 12A-12C, 16 is configured to output the location information of the target emergency locator apparatus 14 on their respective displays 20. In one example, the displayed location information may be a distance value and directional arrow representing the direction of the target emergency locator apparatus 14 with respect to that locator apparatus.

In an aspect, the processor 13 of one or more of the emergency locator apparatus 12A-12C and 16 is configured to repeat steps 200-204 and 210-212 so as to periodically update the location information of the target emergency locator apparatus 14. Accordingly, the location information of the target emergency locator apparatus 14 can be updated based on the movement of each of the other emergency locator apparatus 12A-12C and 16 as each converges on the downed individual wearing the target emergency locator apparatus 14.

In one example, at least the guide unit emergency locator apparatus 16 is configured to receive, at steps 200 and 202, and store at step 204, all of the context information and sensor data communicated with the other emergency locator apparatus 12A-12C, 14. In this example, the guide unit emergency locator apparatus 16 can periodically or continually determine location information for each of the other emergency locator apparatus 12A-12C, 14, irrespective of any emergency condition communication. In this example, the most recent and accurate location information of the other emergency locator apparatus 12A-12C, 14 can be determined, stored, and/or displayed by the guide unit emergency locator apparatus 16. As stated above, the guide unit emergency locator apparatus 16 can include a relatively more robust processor 13, display 20, and/or power supply (not shown), as compared to that of the other emergency locator apparatus 12A-12C, 14.

In this example, as well as in other scenarios in which an individual in an emergency condition may not be visible, it may be difficult to determine exactly where within a relatively small radius the target individual may be located. For example, a downed individual may have encountered an avalanche and thus may be buried beneath snow such that another skier wearing one of the other emergency locator apparatus 12A-C and 16 may not be able to quickly determine where to dig. Accordingly, in one example, the illumination module 60 of one or more of the emergency locator apparatus 12A-12C, 16 can be configured to emit visible light, using one or more LEDs, in the direction of the target apparatus 14, as provided by the location information. Thereby, snow around and above the target individual can be illuminated by his/her target emergency locator apparatus 14 to aid the other skiers in determining where to dig to find the target individual. In an aspect, a solid state laser (e.g. LED) may be utilized in the emergency locator apparatus 100.

In an aspect, the LED(s) can be configured to substantially align with the directional antenna 38 and can further be configured to orient based on the location information. Also optionally, one or more relatively short range transceivers, such as the ultrasound transceiver 54, can be utilized to provide more granular signal data. Using relatively granular data, the processor 13 can determine the location information, at step 210, when the possible locations of the target emergency apparatus 14 have converged toward a relatively small area.

By use of this technology, individuals or objects can be located more quickly and effectively within a broader range and in conditions in which infrastructure and/or satellite connectivity may be unavailable or unreliable. Where such infrastructure or satellite connectivity is available, or the range of individuals coming to the aid of an individual in an emergency condition is relatively small, the data aggregation techniques of this technology can more precisely determine location information of the individual in an emergency condition. As a result, individuals in an emergency condition can be located more quickly thereby increasing the changes of survival.

Having thus described the basic concept of the invention, it will be rather apparent to those skilled in the art that the foregoing detailed disclosure is intended to be presented by way of example only, and is not limiting. Various alterations, improvements, and modifications will occur and are intended to those skilled in the art, though not expressly stated herein. These alterations, improvements, and modifications are intended to be suggested hereby, and are within the spirit and scope of the invention. Additionally, the recited order of processing elements or sequences, or the use of numbers, letters, or other designations therefore, is not intended to limit the claimed processes to any order except as may be specified in the claims. Accordingly, the invention is limited only by the following claims and equivalents thereto.

What is claimed is:

1. A first emergency locator apparatus configured to locate a target emergency locator apparatus associated with a target object, comprising:
a transceiver configured to establish a standalone wireless local area network to send first context data associated with the first emergency locator apparatus to one or more other designated emergency locator apparatus;
a memory configured to store an emergency locator application, the emergency locator application containing executable instructions;
a processor coupled to the transceiver and configured to execute the emergency locator application upon receiving an emergency signal from a target emergency locator apparatus, the processor configured to process at least a context data received over the network from a transmitting emergency locator apparatus to calculate a location of the target emergency locator apparatus with respect to the first emergency locator apparatus.

2. The apparatus of claim 1, further comprising a display configured to display at least the location of the target emergency locator apparatus with respect to the first emergency locator apparatus.

3. The apparatus of claim 1, wherein the transmitting emergency locator apparatus is the target emergency locator apparatus, wherein the emergency locator apparatus processes location data from the context data of the target emergency locator apparatus and location data of the first emergency locator apparatus to calculate the location of the target locator apparatus relative to the first emergency locator apparatus.

4. The apparatus of claim 3, wherein the transmitting emergency locator apparatus is a second emergency locator apparatus other than the target emergency locator apparatus, wherein second context data received from the second emergency locator apparatus includes at least relative location data between the second emergency locator apparatus and the target locator apparatus, the processor configured to process at least the relative location data and recalculate the location of the target emergency locator apparatus with respect to the first emergency locator apparatus.

5. The apparatus of claim 1, wherein the received context data further comprises round trip time (RTT) data between the transmitting emergency locator apparatus and the target emergency locator apparatus.

6. The apparatus of claim 1, wherein the received context data further comprises a received signal strength indicator (RSSI) data.

7. The apparatus of claim 1, wherein the received context data further comprises sensor data from at least one sensor of the transmitting emergency locator apparatus, the processor configured to process at least a portion of the sensor data in calculating the location of the target emergency locator apparatus with respect to the first emergency locator apparatus.

8. The apparatus of claim 1, wherein the first emergency locator apparatus is configured to transmit a confirmation signal to the target emergency locator apparatus over the network upon receiving the emergency signal, the confirmation signal configured to automatically cause the target emergency locator apparatus to notify the target object that the emergency signal was received by at least one emergency locator apparatus.

9. The apparatus of claim 1, further comprising:
a light emitting element coupled to the processor, wherein the light emitting element is configured to operatively emit visible light in a direction of the target emergency locator apparatus based on data received from the processor.

10. The apparatus of claim 1, wherein the wireless network is in conformance with an IEEE 802.11 protocol.

11. A method for locating a target object using a plurality of emergency locator apparatus, the method comprising:
communicating data between a plurality designated emergency locator apparatus configured to access a standalone wireless local area network;
receiving, at a first emergency locator apparatus, an emergency signal over the network from a target emergency locator apparatus associated with the target object;
receiving context data from a transmitting emergency locator apparatus over the network; and
processing at least the received context data to calculate a location of the target emergency locator apparatus with respect to the first emergency locator apparatus.

12. The method of claim 11, further comprising displaying at least the location of the target emergency locator apparatus with respect to the first emergency locator apparatus on a display of the first emergency locator apparatus.

13. The method of claim 11, wherein the transmitting emergency locator apparatus is the target emergency locator apparatus, the method further comprising:
determining current location data of the first emergency locator apparatus; and
processing the received context data of the target emergency locator apparatus along with the current location data of the first emergency locator apparatus to calculate the location of the target locator apparatus relative to the first emergency locator apparatus.

14. The method of claim 13, wherein the transmitting emergency locator apparatus is a second emergency locator apparatus other than the target emergency locator apparatus, the method further comprising:
processing second context data from the second emergency locator apparatus, wherein the second context data includes location information of the second emergency locator apparatus and relative location information between the second emergency locator apparatus and the target emergency locator apparatus;
recalculating the location of the target emergency locator apparatus with respect to the first emergency locator apparatus based on at least the second context data.

15. The method of claim 11, wherein the received context data further comprises round trip time (RTT) data between the transmitting emergency locator apparatus and the target emergency locator apparatus.

16. The method of claim 11, wherein the received context data further comprises a received signal strength indicator (RSSI) data.

17. The method of claim 11, wherein the received context data further comprises sensor data from at least one sensor of the transmitting emergency locator apparatus, wherein at least a portion of the sensor data is processed in calculating the location of the target emergency locator apparatus with respect to the first emergency locator apparatus.

18. The method of claim 11, further comprising:
transmitting a confirmation signal to the target emergency locator apparatus over the network upon receiving the emergency signal, wherein the confirmation signal is configured to automatically cause the target emergency locator apparatus to notify the target object that the emergency signal was received by at least one emergency locator apparatus.

19. The method of claim 11, further comprising:
receiving, at a light emitting element of the first emergency locator apparatus, input data from a processor; and
emitting a visible light from the light emitting element in a direction toward the location of the target emergency locator apparatus based on the input data.

20. A system for locating a target object having a target emergency locator apparatus, the system comprising:
a plurality of emergency locator apparatus, each emergency locator apparatus including a processor and a transceiver coupled to the processor, wherein each emergency locator apparatus wirelessly communicates with one another over the network;
a target emergency locator apparatus including a transceiver configured to periodically send and receive communications with each of the plurality of emergency locator apparatus and a processor operably coupled to the transceiver and configured to determine that a user of the target emergency locator is in an emergency condition and send an emergency condition communication to each of the plurality of emergency locator apparatus, wherein each of the plurality of emergency locator apparatus further includes a processor operably coupled to the transceiver and configured to receive the emergency condition communication and determine location information of the target emergency locator apparatus, in response to the emergency condition communication, utilizing at least context information associated with the communications received from the target emergency locator apparatus and each other of the plurality of emergency locator apparatus.

21. The system of claim 20, wherein the context information includes at least one of a round trip time (RTT) or a received signal strength indicator (RSSI) and the location information further comprises at least a direction and a distance.

22. The system of claim 20, wherein: the communications include data obtained from one or more sources selected from an accelerometer, a gyroscope, a compass, an altimeter, a thermometer, or a global positioning system (GPS) receiver; each of the plurality of emergency locator apparatus is further configured to periodically send and receive signals with one or more devices selected from a frequency modulated continuous-wave (FMCW) transceiver, an ultra-wide band (UWB) transceiver, a 2.4 GHz Doppler scanning transceiver, or a 457 kHz transceiver, or an ultrasound transceiver; and the processor of each of the plurality of emergency locator apparatus is further configured to determine the location information of the target emergency locator apparatus based on one or more of the communicated data or the received signals.

23. The system of claim 20, wherein the processor of each of the plurality of emergency locator apparatus is further configured to output a notification in response to the emergency condition communication, wherein the notification includes at least one of a visual signal, a sensory signal, or an audible signal using a speaker.

24. The system of claim 20, further comprising wherein each of the plurality of emergency locator apparatus further comprises a directional antenna coupled to the transceiver and a light emitting diode (LED) substantially aligned with the directional antenna and configured to operatively emit visible light in a direction of the target emergency locator apparatus.

25. The system of claim 20, wherein the processor of each of the plurality of emergency locator apparatus is further configured to convert voice communications received from at least one other of the plurality of emergency locator apparatus into at least one of analog signals or text and output the converted voice communications using a speaker or the display; and convert audio signals produced by a microphone into voice communications and send the voice communications to at least one other of the plurality of emergency locator apparatus.

26. The system of claim 20, wherein the periodically sending and receiving further comprises periodically sending and receiving the communications in conformance with an IEEE 802.11 protocol.
